(19) United States
(12) Patent Application Publication
(10) Pub. No.: US 2023/0375057 A1
(43) Pub. Date: Nov. 23, 2023

(54) FRICTION PART

(71) Applicant: Schaeffler Technologies AG & Co. KG, Herzogenaurach (DE)

(72) Inventor: Stefan Steinmetz, Essingen (DE)

(73) Assignee: Schaeffler Technologies AG & Co. KG, Herzogenaurach (DE)

(21) Appl. No.: 18/031,168

(22) PCT Filed: Sep. 14, 2021
(86) PCT No.: PCT/DE2021/100756

§ 371 Date: Apr. 11, 2023

(30) Foreign Application Priority Data
Oct. 14, 2020 (DE) 10 2020 126 942.0

(51) Int. Cl. F16D 65/12; F16D 13/64; F16D 13/66

(52) U.S. Cl. CPC F16D 65/127; F16D 13/648; F16D 13/66; F16D 2065/024

(57) ABSTRACT

A friction part for a frictionally operating device includes an annular-disc-like friction surface rotatable about a rotational axis in a wet-running manner relative to a mating surface. The annular-disc-like friction surface is formed from a paper material and includes a meso-geometric or a micro-geometric uneven portion in order to create an axially deep friction region and an axially high friction region in the annular-disc-like friction surface. The axially high friction region is more strongly preloaded than the axially deep friction region when the annular-disc-like friction surface and the mating surface are axially pressed together.

### CROSS-REFERENCE TO RELATED APPLICATIONS

This application is the United States National Phase of PCT Appln. No. PCT/DE2021/100756 filed Sep. 14, 2021, which claims priority to German Application No. DE102020126942.0 filed Oct. 14, 2020, the entire disclosures of which are incorporated by reference herein.

### TECHNICAL FIELD

The present disclosure relates to a friction part for a frictionally operating device. The friction part includes at least one annular-disc-like friction surface which is rotated about a rotational axis in a wet-running manner relative to a mating surface and is formed from a paper material. The present disclosure further relates to a wet-running multi-plate clutch or multiple-disc brake with at least one such friction part.

### BACKGROUND

From the German patent application DE 10 2009 013 406 A1, a method for producing a friction lining in a cooling press is known, which has a conically shaped pressing tool. From the German patent application DE 10 2011 086 926 A1, a friction clutch with friction surfaces and friction linings is known, which are conical in relation to a rotational axis of the friction clutch. From the German patent application DE 10 2015 206 018 A1 a disc clutch with inner plates is known which have annular cross-sections which taper radially outwards in a contact region, wherein outer plates have annular cross-sections which taper radially inwards in the contact region.

### SUMMARY

The present disclosure provides a friction part for a frictionally operating device. The friction part has at least one annular-disc-like friction surface which is rotated about a rotational axis in a wet-running manner relative to a mating surface and is formed from a paper material. The friction surface has at least one meso-geometric or micro-geometric uneven portion in order to create, in the friction surface, at least one axially deep friction region and at least one axially high friction region which is more strongly preloaded than the axially deep friction region when the friction surface and the mating surface are axially pressed together. The term axial refers to the rotational axis of the friction part. Axial means in the direction of or parallel to the rotational axis of the frictional part. The terms radial and tangential used below also refer to the rotational axis of the friction part. Radial means transverse to the rotational axis of the friction part.

The friction part includes at least one friction lining made of a paper material. This friction lining is also referred to as paper lining or friction paper. The paper lining or friction lining is, for example, firmly bonded to a corresponding carrier element. Paper linings are made in a similar way to paper. In the manufacture of paper linings, for example, a paper web is produced from which the paper lining is cut. The paper lining that has been cut out can then be bonded to the carrier element. Pieces of paper lining or pieces of friction paper that are cut out or punched out are also referred to as pads. These pieces of friction paper or pads are then bonded to the carrier element spaced apart from one another. The spacings between the pieces of paper lining or pieces of friction paper allow grooves to be produced in the friction surface, which allow a cooling and/or lubricating medium, such as oil, to pass through.

The carrier element is designed, for example, as a carrier plate and can be corrugated or uncorrugated. Conventional wet-running friction papers, which are also referred to as wet-running papers, normally have a macro-geometric and meso-geometric flat surface over the entire circumference of a friction plate. In the case of the disclosed friction part, the surface of the wet-running friction paper is deliberately not even, i.e. it is uneven. In order to realize the at least one axially deep region and the at least one axially high region, the paper material for representing the friction surface can be designed differently. The surface of the paper material can, for example, be conical, e.g., with a single cone or double-conical, or spherical.

In this case, a spacing between the axially deep region and the axially high region of the friction surface is rather small; e.g., the spacing is in the micron range. The spacing, which is realized, for example, by a targeted conicity or by a spherical shape of the paper material, means that when a contact pressure is applied, the high friction region(s) are more strongly preloaded than the deep friction region(s), whereby the deep friction region(s) lead to a forced separation from the mating surface when the contact pressure is removed. This makes it easier for air to enter the friction gap. In addition, an oil film thickness in the friction contact region can be increased by a suitable design of the friction surface between the axially deep friction region and the axially high friction region, which in turn leads to a higher level of friction. A drag torque during operation of the frictionally engaged device can be reduced by the claimed friction part, e.g., without the use of corrugated springs. In addition, the static friction level can be increased.

In an example embodiment of the friction part, the friction surface is conical. According to this exemplary embodiment, the entire friction surface formed with the paper material is conical. In this case, the friction surface can be designed conically inwards or conically outwards. This means that the axially deep friction region is arranged either radially on the inside or radially on the outside. Similarly, the radially high friction region is arranged radially on the outside or inside.

In a further exemplary embodiment of the friction part, the friction surface is double-conical. In a double-conical design, the friction surface has one axially deep friction region and two axially high friction regions or one axially high friction region and two axially deep friction regions. The friction surface of the double-conical design may be represented with pieces of friction paper, as explained below.

In another exemplary embodiment of the friction part, the friction surface is formed from pieces of friction paper, of which at least one piece of friction paper has at least one meso-geometric or micro-geometric uneven portion in order to create with the piece of friction paper at least one axially deep friction region and at least one axially high friction region which is more strongly preloaded than the axially deep friction region when the friction surface and the mating surface are axially pressed together. The use of the pieces of friction paper or pads enables a desired groove pattern to be produced in the friction surface in a simple manner.

In a further exemplary embodiment of the friction part, the piece of friction paper is conical in relation to a radial. A conical friction surface, which is interrupted by grooves, can thus be realized in a simple manner over the circumference of the friction part.

In a further exemplary embodiment of the friction part, the piece of friction paper is conical in relation to a tangential. Tangentially conical means, for example, that an axial dimension of the piece of friction paper between the axially deep friction region and the axially high friction region increases steadily in the tangential direction. In this way, a higher preloading can be realized in a simple manner in the tangential direction on the piece of friction paper. A cone in the direction of rotation can also reduce the risk of undesired floating during operation of the friction part. Depending on the design of the cone, a higher oil film thickness and thus a higher coefficient of friction can also be achieved.

In a further exemplary embodiment of the friction part, the piece of friction paper is double-conical. In this way, a higher preloading on the piece of friction paper can be realized in the tangential direction. When the contact pressure is removed, air can penetrate more easily into the resulting gap of the double-conical design, which simplifies separation from the mating surface.

In a further exemplary embodiment of the friction part, the piece of friction paper is spherical. The piece of friction paper can be spherical in the radial and/or in the tangential direction. By means of a spherical design at the level of the pieces of friction paper, which are also referred to as individual pads, a uniformity of the contact pressure can be achieved, which overall homogenizes the energy input in relation to the friction surface. As a result, local overloads can be avoided or reduced. This effectively increases the performance of the friction system.

In a further exemplary embodiment of the friction part, an axial distance between the axially deep friction region and the axially high friction region is between five and one hundred microns. In view of the advantages presented, this region has proven to be particularly effective.

The present disclosure further relates to a wet-running multi-plate clutch or multiple-disc brake with at least one previously described friction part. The friction part may be a friction plate, which is equipped on both sides with the friction paper or piece(s) of friction paper described above.

### BRIEF DESCRIPTION OF THE DRAWINGS

Further advantages, features and details of the disclosure will be apparent from the following description, in which various exemplary embodiments are described in detail with reference to the drawing. In the figures:

FIG. 1 shows a friction part with a friction surface in plan view;

FIG. 2 shows a cross-section through the friction part from FIG. 1 according to a first exemplary embodiment with a conical friction surface;

FIG. 3 shows a tangential section through the friction part from FIG. 1 according to a second exemplary embodiment with conical pieces of friction paper; and

FIG. 4 shows an exemplary embodiment similar to that in FIG. 3 with double-conical pieces of friction paper.

### DETAILED DESCRIPTION

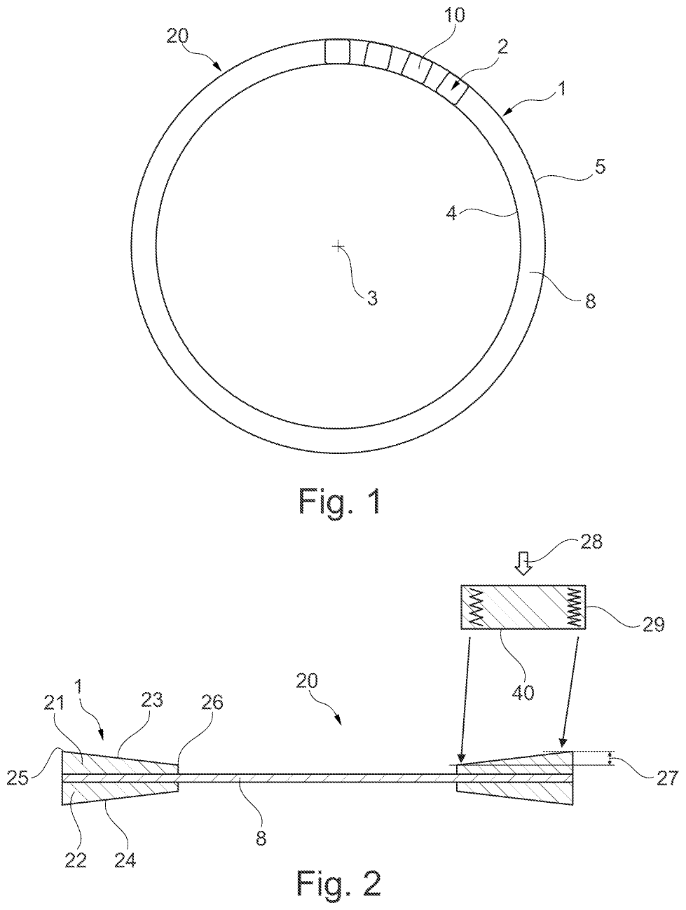

In FIG. 1, a friction part 1 with a friction surface 2 is shown in plan view. The friction part 1 is a friction plate for a frictionally operating device 20. The frictionally operating device 20 is, for example, a multi-plate clutch or a multiple-disc brake.

During operation of the frictionally operating device 20, the friction part 1 can be rotated about a rotational axis 3. The friction surface 2 essentially has the shape of a circular ring disc with an inner diameter 4 and an outer diameter 5. The friction surface 2 is shown with a friction lining, which may be designed as friction paper.

The friction paper can represent the entire friction surface 2. FIG. 1 shows that the friction surface 2 that is continuous in the circumferential direction can also be represented with pieces of friction paper 10. The pieces of friction paper 10 are spaced apart from one another in the circumferential direction, such that there are radial grooves between the pieces of friction paper 10.

The friction paper or the pieces of friction paper 10 are glued onto a carrier element 8. Contrary to what is shown, the carrier element 8 is equipped with toothing radially on the inside or radially on the outside. The toothing is used to create a non-rotatable connection with a plate carrier (also not shown) of the frictionally operating device 20.

The frictionally operating device 20 with the friction part 1 is operated wet. This means that a cooling and/or lubricating medium, such as oil, is conducted past the friction surface 2. Normally, the friction surface 2 is flat. The friction surface 2 of the disclosed friction part 1 is designed to be uneven or not even.

FIGS. 2 to 4 show different sectional views according to three embodiments of the claimed friction part 1 with uneven friction surfaces 23, 24; 33, 34; 43, 44. The uneven friction surfaces 23, 24; 33, 34; 43, 44 are covered with pieces of friction paper 21, 22; 31, 32; 41, 42, which are glued to the carrier element 8 on both sides.

An arrow 28; 38; 49 indicates a contact pressure which is applied, for example, to the friction part 1 with the friction surface 23, 24; 33, 34; 43, 44 via a steel plate indicated only by a rectangle 29; 39; 50. When applying the contact pressure 28; 38; 49 the steel plate is pressed against the friction surface 23; 33; 43 with a mating surface 40.

By means of symbolically indicated springs in the rectangle 29; 39; 50, FIGS. 2 to 4 indicate how the purposefully uneven shape of the friction surface 23, 24; 33, 34; 43, 44 affects the operation of the frictionally operating device 20.

In FIG. 2, the pieces of friction paper 21, 22 are conical. The result of this is that the friction surface 23 has an axially high friction region 25 radially on the outside and an axially deep friction region 26 radially on the inside. An axial distance between the two friction regions 25 and 26 is indicated by a double arrow 27.

It should be noted that FIGS. 2 to 4 are not to scale. The spacing 27 between the friction regions 25 and 26 is five to one hundred microns. In contrast to what is shown in FIG. 2, the axially high friction region 25 can also be arranged radially on the inside. Then the axially deep friction region 26 is arranged radially on the outside.

The conically designed friction paper or piece of friction paper 21 is easy to produce; for example, by a conical design of a pressing tool or gluing tool.

In FIG. 2, the conical design of the piece of friction paper 21 results in a higher preloading of the friction part 1 on the outer diameter. When the contact pressure 28 is removed, the conical design of the piece of friction paper 21 leads to the formation of a gap between the friction surface 23 and the mating surface 40 through which air can easily penetrate. This supports the separation of the friction surface 23 from the mating surface 40 during operation of the wet-running frictionally operating device 20.

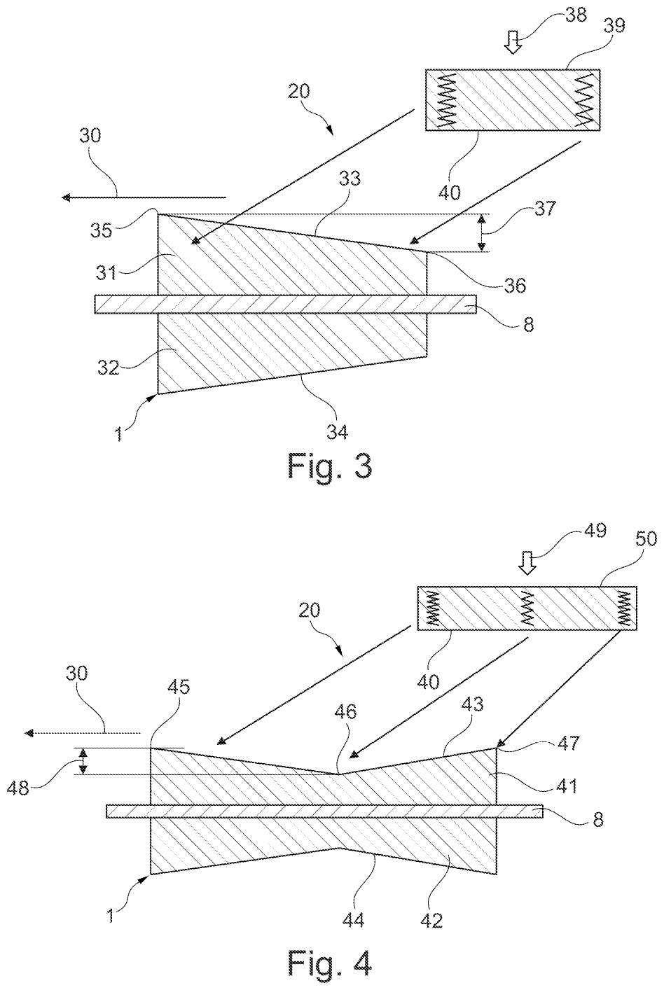

FIGS. 3 and 4 show tangential sections. The tangential direction is indicated by an arrow 30. In FIG. 3, the pieces of friction paper 31, 32 are conical. In FIG. 4, the pieces of friction paper 41, 42 are double-conical.

In FIG. 3, the friction surface 33 has an axially high friction region 35 and an axially deep friction region 36. The spacing 37 between the two friction regions 35 and 36 is five to one hundred microns, as in the previous exemplary embodiment. The axial dimension of the friction surface 33 increases steadily from the axially deep friction region 36 until the axially high friction region 35 is reached.

The embodiment of the piece of friction paper 31 with the friction surface 33 shown in FIG. 3 results in a higher preload in the tangential direction. The cone in the direction of rotation reduces the risk of undesired floating.

In FIG. 4, the pieces of friction paper 41, 42 are double-conical. The friction surface 43 comprises two axially high friction regions 45 and 47. An axially deep friction region 46 is arranged therebetween. The axial dimension of the piece of friction paper 41 changes steadily between the friction regions 46 and 45, 47. The distance 48 between the axially high friction regions 45, 47 and the axially low friction region 46 is five to one hundred microns.

The double-conical design results in a higher preload on the piece of friction paper 41 in the tangential direction on both edges, i.e. radially on the outside, when the contact pressure 49 is applied. The edges of the piece of friction paper 41 may be spherical.

### REFERENCE NUMERALS

1 Friction part
2 Friction surface
3 Rotational axis
4 Inside diameter
5 Outside diameter
8 Carrier element
10 Piece of friction paper
20 Wet-running multi-plate clutch
21 Piece of friction paper
22 Piece of friction paper
23 Friction surface
24 Friction surface
25 Axially high friction region
26 Axially deep friction region
27 Double arrow
28 Arrow
29 Rectangle
30 Arrow
31 Piece of friction paper
32 Piece of friction paper
33 Friction surface
34 Friction surface
35 Axially high friction region
36 Axially deep friction region
37 Double arrow
38 Arrow
39 Rectangle
40 Mating surface
41 Piece of friction paper
42 Piece of friction paper
43 Friction surface
44 Friction surface
45 Axially high friction region
46 Axially deep friction region
47 Axially high friction region
48 Double arrow
49 Arrow
50 Rectangle

1. A friction part for a frictionally operating device, comprising at least one annular-disc-like friction surface which is rotated about a rotational axis in a wet-running manner relative to a mating surface and is formed from a paper material, wherein the friction surface has at least one meso-geometric or micro-geometric uneven portion in order to create, in the friction surface, at least one axially deep friction region and at least one axially high friction region which is more strongly preloaded than the axially deep friction region when the friction surface and the mating surface are axially pressed together.

2. The friction part according to claim 1, wherein the friction surface is conical.

3. The friction part according to claim 1, wherein the friction surface is double-conical.

4. The friction part according to claim 1, wherein the friction surface is formed from pieces of friction paper, of which at least one piece of friction paper has the meso-geometric or micro-geometric unevenness to create with the piece of friction paper the at least one axially deep friction region and the at least one axially high friction region which is more strongly preloaded than the axially deep friction region when the friction surface and the mating surface are axially pressed together.

5. The friction part according to claim 4, wherein the piece of friction paper is conical in relation to a radial.

6. The friction part according to claim 4, wherein the piece of friction paper is conical in relation to a tangential.

7. The friction part according to claim 4, wherein the piece of friction paper is double-conical.

8. The friction part according to claim 4, wherein the piece of friction paper is spherical.

9. The friction part according to claim 1, wherein an axial distance between the axially deep friction region and the axially high friction region is between five and one hundred microns.

10. A wet-running multi-plate clutch or multiple-disc brake having at least one friction part according to claim 1.

11. A friction part for a frictionally operating device, comprising an annular-disc-like friction surface rotatable about a rotational axis in a wet-running manner relative to a mating surface, the annular-disc-like friction surface being formed from a paper material and comprising a meso-geometric or a micro-geometric uneven portion in order to create an axially deep friction region and an axially high friction region in the annular-disc-like friction surface, wherein the axially high friction region is more strongly preloaded than the axially deep friction region when the annular-disc-like friction surface and the mating surface are axially pressed together.

12. The friction part of claim 11, wherein the annular-disc-like friction surface is conical.

13. The friction part of claim 11, wherein the annular-disc-like friction surface is double-conical.

14. The friction part of claim 11, wherein:
the annular-disc-like friction surface is formed from individual pieces of friction paper; and
one of the individual pieces of friction paper includes the meso-geometric or the micro-geometric uneven portion that creates the axially deep friction region and the axially high friction region.

15. The friction part of claim 14, wherein the one of the individual pieces of friction paper is conical in a radial direction relative to the rotational axis.

16. The friction part of claim 14, wherein the one of the individual pieces of friction paper is conical in a tangential direction relative to the rotational axis.

17. The friction part of claim 14, wherein the one of the individual pieces of friction paper is a double-conical.

18. The friction part of claim 14, wherein the one of the individual pieces of friction paper is spherical.

19. The friction part of claim 11, wherein an axial distance measured between the axially deep friction region and the axially high friction region is between five microns (0.005 mm) and one hundred microns (0.100 mm).
